(19) United States
(12) Patent Application Publication
(10) Pub. No.: US 2025/0036254 A1
(43) Pub. Date: Jan. 30, 2025

(54) MESSAGE DISPLAY IN VIRTUAL ENVIRONMENT

(71) Applicant: TENCENT TECHNOLOGY (SHENZHEN) COMPANY LIMITED, Shenzhen (CN)

(72) Inventors: Siyuan WANG, Shenzhen (CN); Teng CHEN, Shenzhen (CN); Qien DONG, Shenzhen (CN); Guanjun ZHANG, Shenzhen (CN)

(73) Assignee: TENCENT TECHNOLOGY (SHENZHEN) COMPANY LIMITED, Shenzhen, GD (CN)

(21) Appl. No.: 18/916,681

(22) Filed: Oct. 15, 2024

Related U.S. Application Data
(63) Continuation of application No. PCT/CN2023/113751, filed on Aug. 18, 2023.

(30) Foreign Application Priority Data
Sep. 16, 2022 (CN) 202211129840.9

(51) Int. Cl. G06F 3/04815

(52) U.S. Cl. CPC G06F 3/04815

(57) ABSTRACT

In a method for displaying messages in a virtual environment, a first view of a virtual scene is displayed including virtual objects corresponding to user accounts. A first message is received from a first user account corresponding to a first virtual object located outside the first view. A message notification graphical element is displayed in response to the first message. A first user input selecting the message notification graphical element is received. A second view of the virtual scene is displayed in response to the first user input. The second view includes the first virtual object and displays a message prompt corresponding to the first virtual object. The second view is different from the first view. Apparatus and non-transitory computer-readable storage medium counterpart embodiments are also contemplated.

### RELATED APPLICATIONS

The present application is a continuation of International Application No. PCT/CN2023/113751, filed on Aug. 18, 2023, which claims priority to Chinese Patent Application No. 202211129840.9, filed on Sep. 16, 2022. The entire disclosures of the prior applications are hereby incorporated by reference.

### FIELD OF THE TECHNOLOGY

This application relates to the field of virtual environments, including displaying a message.

### BACKGROUND OF THE DISCLOSURE

With the rapid development of computer technologies and diversification of terminals, electronic games are gradually widely used. Social games are a popular type of game. A virtual scene is displayed on the terminal, and a user performs, by controlling a virtual social object in the virtual scene, various social activities with a virtual social object controlled by another user.

### SUMMARY

Embodiments of this disclosure include a method, apparatus, and a non-transitory computer-readable storage medium for displaying a message to improve message display efficiency. Examples of technical solutions in the embodiments of this disclosure may be implemented as follows:

An aspect of this disclosure provides a method for displaying messages in a virtual environment. A first view of a virtual scene is displayed including virtual objects corresponding to user accounts. A first message is received from a first user account corresponding to a first virtual object located outside the first view. A message notification graphical element is displayed in response to the first message. A first user input selecting the message notification graphical element is received. A second view of the virtual scene is displayed in response to the first user input. The second view includes the first virtual object and displays a message prompt corresponding to the first virtual object. The second view is different from the first view.

An aspect of this disclosure provides an apparatus. The apparatus includes processing circuitry configured to display a first view of a virtual scene including virtual objects corresponding to user accounts. The processing circuitry is configured to receive a first message from a first user account corresponding to a first virtual object located outside the first view. The processing circuitry is configured to display a message notification graphical element in response to the first message. The processing circuitry is configured to receive a first user input to select the message notification graphical element. The processing circuitry is configured to display a second view of the virtual scene in response to the first user input. The second view includes the first virtual object and displays a message prompt corresponding to the first virtual object. The second view is different from the first view.

An aspect of this disclosure provides a non-transitory computer-readable storage medium storing instructions which when executed by a processor cause the processor to perform any of the methods of this disclosure.

Technical solutions provided in the embodiments of this disclosure can have the following beneficial effects.

The scene picture corresponding to the virtual scene is currently displayed in the first observation range. When the social message transmitted from the second social account is received, the message navigator is displayed. When the triggering operation performed on the message navigator is received, the scene picture corresponding to the virtual scene is displayed in the second observation range. The current scene picture includes the second social object. In other words, when the second social account corresponding to the second social object outside the first observation range is controlled to transmit the social message, the observation range of the virtual scene can be automatically switched, by triggering the message navigator, to the observation range where the second social object is located, so as to achieve positioning of a position of the second social object in the virtual scene in one operation, thereby preventing a user from adjusting the observation range a plurality of times in the virtual scene to find the second social object, improving message display efficiency, and also reducing data overheads of a computer.

### BRIEF DESCRIPTION OF THE DRAWINGS

FIG. 1 is a schematic diagram of a method for displaying a message according to an embodiment of this disclosure.

FIG. 2 is a schematic diagram of an implementation environment according to an embodiment of this disclosure.

FIG. 3 is a structural block diagram of an electronic device according to an embodiment of this disclosure.

FIG. 4 is a flowchart of a method for displaying a message according to an embodiment of this disclosure.

FIG. 5 is a flowchart of a method for displaying a message according to another embodiment of this disclosure.

FIG. 6 is a schematic diagram of display of a message navigator according to another embodiment of this disclosure.

FIG. 7 is a schematic diagram of display of a second social object according to an embodiment of this disclosure.

FIG. 8 is a flowchart of a method for displaying a message according to another embodiment of this disclosure.

FIG. 9 is a schematic diagram of a position of a social account according to an embodiment of this disclosure.

FIG. 10 is a schematic diagram of display of a message navigator according to an embodiment of this disclosure.

FIG. 11 is a schematic diagram of display of a message navigator according to another embodiment of this disclosure.

FIG. 12 is a schematic diagram of a message preview list according to an embodiment of this disclosure.

FIG. 13 is a schematic diagram of a display mode of an account identifier according to another embodiment of this disclosure.

FIG. 14 is a schematic diagram of a display mode of an account identifier according to an embodiment of this disclosure.

FIG. 15 is a flowchart of a method for displaying a message according to another embodiment of this disclosure.

FIG. 16 is a timing diagram of a method for displaying a message according to an embodiment of this disclosure.

FIG. 17 is a structure diagram of an apparatus for displaying a message according to an embodiment of this disclosure.

FIG. 18 is a structure diagram of an apparatus for displaying a message according to another embodiment of this disclosure.

FIG. 19 is a structural block diagram of a terminal according to an embodiment of this disclosure.

### DESCRIPTION OF EMBODIMENTS

First, terms involved in embodiments of this disclosure are briefly described. The descriptions of the terms are provided as examples only and are not intended to limit the scope of the disclosure.

Virtual environment: It is a virtual environment displayed (or provided) when an application runs on a terminal. The virtual environment may be a simulation environment for the real world, or may be a semi-simulation and semi-fiction three-dimensional environment, and may also be a purely fictional three-dimensional environment. The virtual environment may be any one of a two-dimensional virtual environment, a 2.5-dimensional virtual environment, and a three-dimensional virtual environment. In the following embodiments, an example in which the virtual environment is the two-dimensional virtual environment is used for description. This is not limited.

Virtual object: It is a movable object in a virtual environment. The movable object may be a virtual chess piece, a virtual character, a virtual animal, a cartoon character, and the like, for example, a character, an animal, a plant, an oil barrel, a wall, and a stone displayed in the virtual environment. In some embodiments, the virtual object is a three-dimensional model created based on a skeletal animation technology. Each virtual object has a shape and a volume in the virtual environment, and occupies a part of space in the virtual environment.

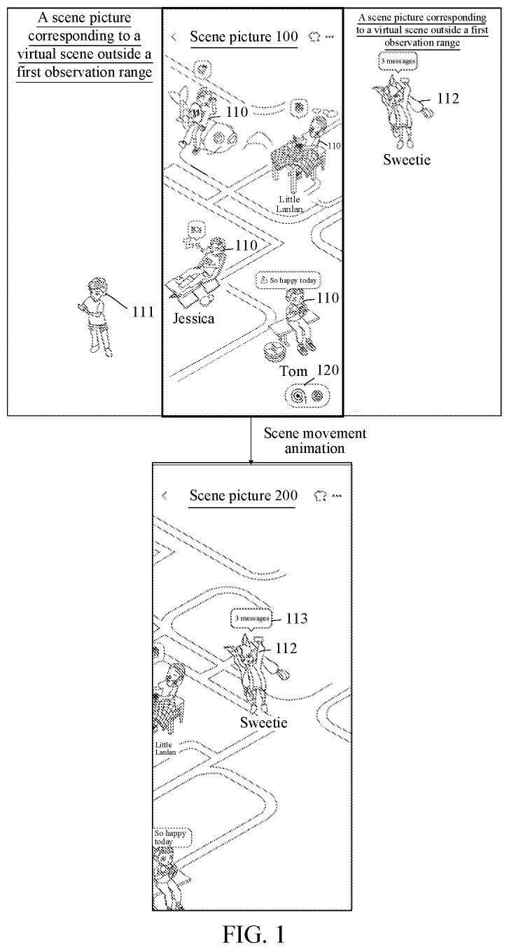

First, FIG. 1 is a schematic diagram showing a method for displaying a message according to an embodiment of this disclosure. As shown in FIG. 1, a scene picture 100 corresponding to a virtual scene is displayed in a first observation range. The scene picture 100 includes a virtual social object 110 corresponding to each of a plurality of social accounts. In addition, a virtual social object 111 and a virtual social object 112 corresponding to another social account are also within the virtual scene but outside the scene picture 100.

When a social message transmitted from a second social account is received, a message navigator 120 is displayed. The virtual social object 112 (namely, a second social object) controlled by the second social account is outside the first observation range. When a triggering operation performed on the message navigator 120 is received, the scene picture 200 corresponding to the virtual scene is displayed in a second observation range. In some embodiments, when the triggering operation performed on the message navigator 120 is received, a scene movement animation is displayed. The scene movement animation is an animation of switching from the first observation range to the second observation range and display of a scene picture corresponding to the second observation range. When playback of the scene movement animation is completed, the scene picture 200 corresponding to the virtual scene is displayed in the second observation range. The scene picture 200 includes the virtual social object 112, and prompt information 113 corresponding to the social message is displayed in a designated area of the virtual social object 112.

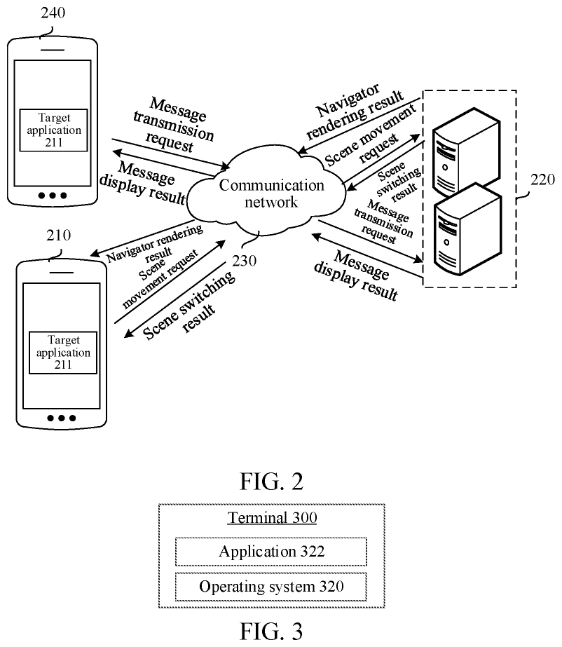

Next, an implementation environment of this disclosure is described. FIG. 2 is a schematic diagram of an implementation environment according to an embodiment of this disclosure. The implementation environment includes a first terminal 210, a server 220, a second terminal 240, and a communication network 230. The first terminal 210, the second terminal 240, and the server 220 are connected through the communication network 230.

A target application 211 is installed and run in both the first terminal 210 and the second terminal 240. The target application 211 is an application that supports a two-dimensional virtual environment or a three-dimensional virtual environment. The target application 211 may be any one of a virtual reality application, a three-dimensional map program, a social game, a chess game, a strategy game, a puzzle game, a third-person shooting game (TPS), a first-person shooting game (FPS), multiplayer online battle arena games (MOBA), and a multiplayer shootout survival game. In a possible implementation, the target application 211 may be a stand-alone application, for example, a stand-alone strategy game program, or may be an online application.

In some embodiments, when the target application 211 is implemented as the stand-alone application, the first terminal 210 is used as an example. A scene picture corresponding to a virtual scene in a first observation range is currently displayed in the target application 211. The virtual scene includes virtual objects corresponding to a plurality of non-player characters (NPCs). In addition, the virtual scene further includes a first social object corresponding to a first social account logged in with a terminal 210. When the terminal 210 receives a message transmitted from a target account, a message navigator is displayed in the scene picture. A virtual object corresponding to the target account is outside a current scene picture. When the terminal 210 receives a triggering operation performed on the message navigator, a scene movement animation is displayed. The scene movement animation is an animation of switching from the first observation range to a second observation range. When playback of the scene movement animation is completed, the scene picture corresponding to the virtual scene is displayed in the second observation range. The virtual object corresponding to the target account is located in the current scene picture. Prompt information corresponding to the message is displayed in a designated area of the virtual object. Message content transmitted from the target account may be subsequently displayed by performing a triggering operation on the prompt information, so as to formulate a relevant game strategy and promote development of a game plot.

In some embodiments, when the target application 211 is implemented as the online application, as shown in FIG. 2, the target application 211 is currently implemented as a social game. The first terminal 210 displays the scene picture corresponding to the virtual scene in the first observation range. The virtual scene includes a first social object corresponding to a first social account logged in with the first terminal 210, and a second social object corresponding to a second social account logged in with the second terminal 240.

When the second terminal 240 receives a message transmission operation, a message transmission request is generated and transmitted to the server 220. The message transmission request includes a social message transmitted from the second social account and position information of the second social object.

When the server 220 receives the message transmission request transmitted from the second terminal 240, position information of the second social account in the virtual scene is determined. If the second social object corresponding to the second social account is in the virtual scene outside the first observation range, a navigator rendering result and a message display result are generated based on the message transmission request, and the navigator rendering result is transmitted to the first terminal 210. The navigator rendering result includes a rendering sub-element corresponding to the message navigator, and the message display result is transmitted to the second terminal 240.

When the first terminal 210 receives the navigator rendering result, the current scene picture is rendered based on the navigator rendering result, and the message navigator is displayed in the current scene picture. When the first terminal 210 receives the triggering operation performed on the message navigator, a scene movement request is generated and transmitted to the server 220. The scene movement request is configured for requesting to move the first observation range to the second observation range where the second social object is located. When the server 220 receives the scene movement request, the second observation range where the second social object is located is determined based on the position information of the second social object in the virtual scene, and a corresponding scene switching result is generated and fed back to the first terminal 210. When the first terminal 210 receives the scene switching result, the scene movement animation is played. After the playback of the scene movement animation is completed, the second social object is displayed in the scene picture of the virtual scene displayed in the second observation range, and prompt information corresponding to the social message is displayed at a designated position of the second social object.

The foregoing terminal may be optional. The terminal may be a terminal device in a plurality of forms such as a desktop computer, a laptop computer, a mobile phone, a tablet computer, an e-book reader, a moving picture experts group audio layer III (MP3) player, a moving picture experts group audio layer IV (MP4) player, a smart television, and smart on-board terminal devices in a plurality of forms. This is not limited in the embodiments of this disclosure.

The server 220 includes at least one of one server, a plurality of servers, a cloud computing platform, and a virtualization center. In some embodiments, the server 220 is in charge of primary computing, and the terminal 210 is in charge of secondary computing. Alternatively, the server 220 is in charge of secondary computing, and the terminal 210 is in charge of primary computing. Alternatively, the server 220 and the terminal 210 perform collaborative computing by using a distributed computing architecture.

The foregoing server may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and artificial intelligence platform.

The cloud technology is a hosting technology that unifies a series of resources such as hardware, software, and a network in a wide area network or a local area network to implement calculation, storage, processing, and sharing of data.

In some embodiments, the foregoing server may further be implemented as a node in a blockchain system.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

FIG. 3 is a structural block diagram showing an electronic device according to an embodiment of this disclosure. An electronic device 300 includes an operating system 320 and an application 322.

The operating system 320 is basic software that provides secure access to computer hardware for the application 322.

The application 322 is an application that supports a virtual environment. In some embodiments, the application 322 is an application that supports a three-dimensional virtual environment. The application 322 may be any one of a virtual reality application, a three-dimensional map program, a TPS, an FPS, an MOBA, or a multiplayer shootout survival game, a social game, a puzzle game, and a strategy game. The application 322 may be a stand-alone application, for example, a stand-alone game program, or may be an online application.

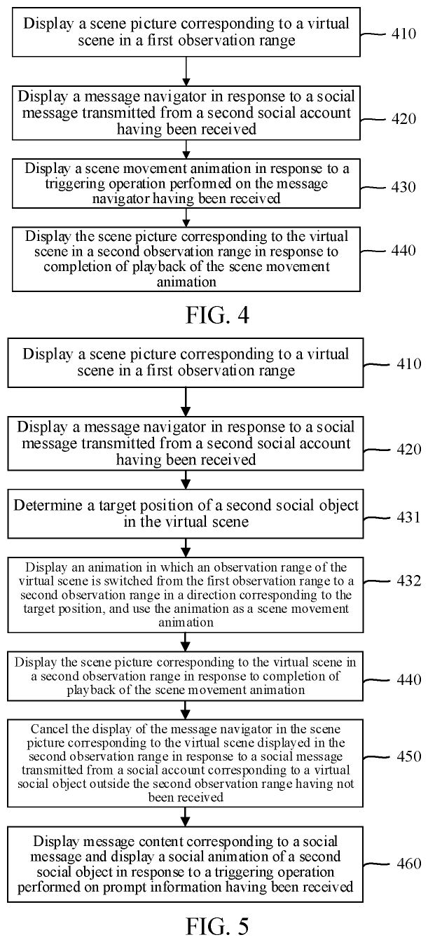

Based on the foregoing description, a method for displaying a message provided in this disclosure is described. The method may be performed by an electronic device. The electronic device may be the electronic device 300 shown in FIG. 3. The electronic device may be a server or a terminal, or the electronic device may include a server and a terminal. For example, the terminal may be the first terminal 210 or the second terminal 240 in FIG. 1, and the server may be the server 220 in FIG. 1. In this embodiment of this disclosure, an example in which the method is performed by the terminal is used for description. As shown in FIG. 4, the method includes the following operations.

Operation 410: Display a scene picture corresponding to a virtual scene in a first observation range. For example, a first view of a virtual scene is displayed including virtual objects corresponding to user accounts.

The virtual scene includes a virtual social object corresponding to each of a plurality of social accounts, and includes a first social object corresponding to a first social account logged in with a terminal.

Exemplarily, the first observation range refers to a perspective range for observing the virtual scene from a perspective of the first social object corresponding to the first social account logged in with the terminal.

In some embodiments, the foregoing first social object perspective may be implemented as a first-person perspective, or the foregoing first social object perspective may be implemented as a third-person perspective. This is not limited.

Exemplarily, the virtual social object refers to a virtual object that is controlled by the social account and may perform a social activity in the virtual scene. The social activity includes at least one of the activities such as chatting, transmitting a voice message, sharing a video, sharing a picture, completing an assigned task (for example, an action of “finger heart” jointly performed by a social object 1 and a social object 2, or a specified dance completed by a social object a), and posting dynamic content.

In some embodiments, the social activity includes that the social account controls the virtual social object to perform the activity alone, or a plurality of social accounts control the corresponding virtual social objects to jointly perform the activity. This is not limited.

In some embodiments, the first social account corresponds to at least one first social object in the virtual scene.

In some embodiments, some of the virtual social objects respectively corresponding to the plurality of social accounts included in the virtual scene are displayed in the scene picture corresponding to the first observation range, and some of the virtual social objects are not displayed in the scene picture corresponding to the first observation range.

In some embodiments, the virtual social object corresponding to each of the plurality of social accounts is located at a fixed position of the virtual scene, or the virtual social object corresponding to each of the plurality of social accounts is movable in the virtual scene.

Operation 420: Display a message navigator in response to a social message transmitted from a second social account having been received. For example, a message notification graphical element is displayed in response to the first message.

A second social object corresponding to the second social account is outside the first observation range. The message navigator is configured to indicate that a social message transmitted from a social account corresponding to a virtual social object outside the first observation range is received.

Exemplarily, the second social object controlled by the second social account is in a virtual scene outside the first observation range.

In some embodiments, the message navigator is configured to indicate that at least one social account corresponding to the virtual social object outside the first observation range has transmitted a social message. The social message may be a message published on a public platform by the social account corresponding to the virtual social object outside the first observation range, or may be a message transmitted from the social account corresponding to the virtual social object outside the first observation range to the first social account, and may further be a message transmitted from the social account corresponding to the virtual social object outside the first observation range in a group where the first social account is located.

In some embodiments, the message navigator includes at least one of content such as an account identifier corresponding to the social account that transmits the social message, an account quantity for the social account that transmits the social message, time the social message is transmitted, and a type of the transmitted social message.

In some embodiments, when the social message transmitted from a single social account is received, then the message navigator is displayed in the virtual scene. Alternatively, after social messages respectively transmitted from a specified quantity of social accounts are received, the message navigator is displayed in the virtual scene. This is not limited.

In some embodiments, a display mode of the message navigator includes at least one of the following modes.

1. When the social message transmitted from the second social account is received, the message navigator is displayed in the virtual scene and the account identifier corresponding to the second social account is displayed in the message navigator if no other social account outside the first observation range has transmitted a social message before. If another social account outside the first observation range has transmitted the social message currently and the message navigator has been displayed in the virtual scene, the account identifier corresponding to the second social account is added to the message navigator for display. In other words, only one message navigator exists in a current virtual scene.

2. When the social message transmitted from the second social account is received, the message navigator corresponding to the second social account is displayed in the virtual scene. If the social message transmitted from another social account is received again and the virtual social object corresponding to the another social account is also outside the first observation range, the message navigator corresponding to the another social account is displayed in the virtual scene. In other words, each social account corresponds to one independent message navigator, and the virtual scene may include a plurality of message navigators respectively corresponding to different social accounts that transmit the social messages.

The foregoing display mode of the message navigator is only a schematic example. This is not limited in the embodiments of this disclosure.

In a first case of the foregoing display mode, in an solution, if another social account outside the first observation range has transmitted the social message currently and the message navigator has been displayed in the virtual scene, the account identifier corresponding to the second social account is displayed in the message navigator when the social message transmitted from the second social account is received, and the account identifier is located after the account identifier corresponding to the another social account that has transmitted the social message. To be specific, if the social message transmitted from each of the plurality of social accounts is received, the account identifiers respectively corresponding to the plurality of social accounts are successively displayed in the message navigator simultaneously based on a time sequence in which the plurality of social accounts transmit the social messages. In other words, the message navigator supports simultaneous displaying of a plurality of account identifiers.

In a second case of the foregoing display mode, in another solution, if another social account located outside the first observation range has transmitted the social message currently and the message navigator has been displayed in the scene picture, the account identifier corresponding to the second social account is displayed in the message navigator and an animation in which the account identifiers respectively corresponding to the another social account and the second social account are displayed in turn and circularly is played in the message navigator when the social message transmitted from the second social account is received. To be specific, when the social message transmitted from each of the plurality of social accounts is received, the account identifiers respectively corresponding to the plurality of social accounts are displayed in turn in the message navigator based on a transmission sequence of the social messages, and only one account identifier is displayed at a time. In other words, the message navigator supports displaying of only one account identifier at one time.

In a third case of the foregoing display mode, in an solution, if the social message transmitted from each of the plurality of social accounts is currently received, the message navigator corresponding to each of the plurality of social accounts is displayed in the scene picture, and a display position of the message navigator corresponding to each social account in the scene picture corresponds to a position of the virtual social object corresponding to the social account in the virtual scene. For example, if an object A is located in a virtual scene in a northeast direction outside the first observation range, the message navigator corresponding to the social account is displayed at a specified position in a northeast direction of the scene picture corresponding to the virtual scene displayed in the first observation range when the social message transmitted from the social account corresponding to the object A is received.

Operation 430: Display a scene movement animation in response to a triggering operation performed on the message navigator having been received. For example, a second view of the virtual scene is displayed in response to the first user input. In an example, an animation transitioning from the first view to the second view is displayed.

The scene movement animation is an animation in which an observation range of the virtual scene is switched from the first observation range to a second observation range. The second social object is within the second observation range.

In some embodiments, the second observation range refers to a perspective range for observing the virtual scene from a perspective of the first social object corresponding to the first social account logged in with the terminal.

In an example, the second observation range is an observation range with the second social object as a center.

In an example, when the social message transmitted from each of the plurality of social accounts is received, the second observation range is the observation range that includes all of the virtual social objects corresponding to the plurality of social accounts.

In some embodiments, the second observation range and the first observation range are two different observation ranges. Alternatively, the second observation range and the first observation range partially overlap. This is not limited.

In some embodiments, a focal length of a perspective corresponding to the second observation range is the same as a focal length of the perspective corresponding to the first observation range. To be specific, a process of switching from the first observation range to the second observation range only involves rotation of the perspective in a direction. Alternatively, the focal length of the perspective corresponding to the second observation range is different from the focal length of the perspective corresponding to the first observation range. To be specific, the process of switching from the first observation range to the second observation range involves not only the rotation of the perspective in the direction, but also a change in the focal length of the perspective (for example, the focal length is increased or reduced). This is not limited.

In some embodiments, the scene movement animation includes at least one of the following animation content.

1. The scene movement animation refers to an animation of perspective movement of a first social object perspective from the first observation range to the second observation range.

2. The scene movement animation refers to an animation in which the current scene picture is directly transformed from the scene picture corresponding to the first observation range to the scene picture corresponding to the second observation range.

3. The scene movement animation refers to an animation in which display of the current scene picture corresponding to the first observation range is gradually canceled, and the scene picture corresponding to the second observation range is gradually displayed.

4. The scene movement animation is an animation in which the focal length of the perspective corresponding to the first observation range gradually changes, thereby generating the second observation range with different focal lengths of the perspective.

The foregoing animation content of the scene movement animation is only a schematic example. This is not limited in the embodiments of this disclosure.

For the first case, the second case, and the third case of the foregoing animation content, in an implementable case, if the social message transmitted from a third social account is received (the third social object corresponding to the third social account is outside the second observation range), and the triggering operation performed on the message navigator is received again, the scene movement animation of switching from the second observation range to a third observation range is displayed.

In a fourth case of the foregoing animation content, in an implementable case, the second observation range is an animation in which the focal length of the perspective is shorter than that in the first observation range, and the second social object is displayed at a central position of the second observation range.

In the fourth case of the foregoing animation content, in an implementable case, the scene movement animation means that the focal length of the perspective corresponding to the first observation range is gradually increased, so that the observation range corresponding to the increased focal length is expanded, and the current observation range includes the second social object. Then the focal length of the perspective of the current observation range is reduced in a direction of a position based on the position of the second social object in the current observation range, so as to finally obtain the second observation range, and the second observation range includes only the second social object. If the social message transmitted from the third social account is received (the third social object corresponding to the third social account is outside the second observation range), and the triggering operation performed on the message navigator is received again, the third observation range including only the third social object is generated after the scene movement animation with a perspective of “zooming in and then zooming out” corresponding to the second observation range is displayed.

In some embodiments, the triggering operation performed on the message navigator includes at least one of the following triggering operations.

1. The message navigator includes the account identifier corresponding to the second social account. The triggering operation performed on the message navigator may be implemented as a triggering operation performed on the account identifier corresponding to the second social account.

2. The triggering operation performed on the message navigator may be implemented as a triggering operation performed on a control corresponding to the message navigator.

The foregoing triggering operation of the message navigator is only a schematic example. This is not limited in the embodiments of this disclosure.

In an example, when the social message transmitted from each of the plurality of social accounts are received, the scene movement animation is related to a moment the social message transmitted from the social account is received. Based on a time point corresponding to the received social message transmitted from each of the plurality of social accounts, a scene movement animation corresponding to the social account that transmits the social message at a time point nearest the current time point is successively displayed. For example, a social message transmitted from an account 1, a social message transmitted from an account 2, and a social message transmitted from an account 3 are successively received in order of time points from an earliest time point to a latest time point (a transmission time of the account 1 is later than that of the account 2, and the transmission time of the account 2 is later than that of the account 3). Therefore, the scene movement animation is implemented as switching from the first observation range to an observation range of a social object 1 corresponding to the account 1, then switching from the observation range of the social object 1 to an observation range of a social object 2, and finally switching from the observation range of the social object 2 to an observation range of a social object 3. To be specific, the scene movement animation is always performed starting from the social account corresponding to a latest received social message.

In an example, when the social message transmitted from each of the plurality of social accounts are received, the scene movement animation is related to an order of reception in which the social message is received. The corresponding scene movement animations are successively displayed based on the order of reception corresponding to the social message transmitted from each of the plurality of social accounts that are received. For example, a social message transmitted from an account a, a social message transmitted from an account b, and a social message transmitted from an account c are successively received currently (the social message from the account c is the latest in terms of the time of reception, and the social message from the account a is the earliest received message in terms of the order of reception). Therefore, the scene movement animation is implemented as switching from the first observation range to an observation range of a social object a corresponding to the account a, then switching from the observation range of the social object a to an observation range of a social object b corresponding to the account b, and finally switching from the observation range of the social object b to an observation range of a social object c corresponding to the account c. To be specific, the scene movement animation is always performed starting from the social account corresponding to the first received social message.

It may be learned based on the foregoing two cases that in the method for displaying a message provided in this disclosure, the scene movement animation may be successively performed from an earliest time of reception to a latest time of reception of the social message, or may be successively performed from the latest time of reception to the earliest time of reception of the social message. This is not limited.

In this disclosure, an example in which the scene movement animation is successively performed from the latest time of reception to the earliest time of reception of the social message is used for description.

Operation 440: Display the scene picture corresponding to the virtual scene in the second observation range in response to completion of playback of the scene movement animation. For example, the second view is displayed when the animation is completed.

Prompt information corresponding to the social message is displayed in a designated area corresponding to the second social object.

Exemplarily, the completion of playback of the scene movement animation refers to successful switching from the first observation range to the second observation range.

In some embodiments, the scene picture corresponding to the virtual scene displayed in the second observation range includes only the second social object, or includes not only the second social object, but also another virtual social object (including virtual social objects within the first observation range or outside the first observation range). This is not limited.

Exemplarily, the prompt information is configured for indicating at least one of content such as social message content, a social message quantity, and a social message transmission time currently transmitted from the second social account.

In some embodiments, each social message corresponds to a piece of independent prompt information. Alternatively, a plurality of social messages correspond to the same prompt information. This is not limited.

Operation 430 is an example operation. In other words, after the triggering operation performed on the message navigator is received, a picture jump may be performed to display the scene picture corresponding to the virtual scene in the second observation range, without needing to display the scene movement animation.

Based on the above, according to the method for displaying a message provided in the embodiments of this disclosure, the scene picture corresponding to the virtual scene is currently displayed in the first observation range. When the social message transmitted from the second social account is received, the message navigator is displayed. When the triggering operation performed on the message navigator is received, the scene movement animation corresponding to switching from the first observation range to the second observation range is displayed, and the scene picture corresponding to the virtual scene is displayed in the second observation range. The current scene picture includes the second social object. In other words, when the second social account corresponding to the second social object outside the first observation range is controlled to transmit the social message, the observation range of the virtual scene can be automatically switched, by triggering the message navigator, to the observation range where the second social object is located, so as to achieve positioning of a position of the second social object in the virtual scene in one operation, thereby preventing a user from adjusting the observation range a plurality of times in the virtual scene to find the second social object, improving message display efficiency, and also reducing data overheads of a computer.

Another social account/social account in “receiving a social account transmitted from another social account” involved in this disclosure is configured for indicating a social account outside the first observation range.

In an embodiment, an example in which only the social message transmitted from the second social account is currently received is used for description. Exemplarily, FIG. 5 is a flowchart showing a method for displaying a message according to an embodiment of this disclosure. To be specific, operation 430 further includes operation 431 and operation 432. After operation 440, operation 450 and operation 460 are further included. An example in which the method is performed by a terminal is used for description. As shown in FIG. 5, the method includes the following operations.

Operation 420: Display a message navigator in response to a social message transmitted from a second social account having been received. For example, a message notification graphical element is received in response to the first message.

A second social object corresponding to the second social account is outside the first observation range. The message navigator is configured to indicate that a social message transmitted from a social account corresponding to a virtual social object outside the first observation range is received.

In some embodiments, the message navigator includes an account identifier and an account quantity corresponding to the social account that transmits the social message, the account quantity corresponding to a quantity of social accounts from which the social messages have been received and have not been read currently.

Exemplarily, the account identifier is configured for representing identity information corresponding to the social account from which the social messages have been received and have not been read currently. The account quantity is configured for representing a quantity of social accounts outside the first observation range, social messages from which have been received and have not been read currently.

In this embodiment, when only the social message transmitted from the second social account is received, the message navigator is displayed in the scene picture corresponding to the first observation range. The message navigator includes an account identifier and an account quantity (the quantity is 1) corresponding to the second social account.

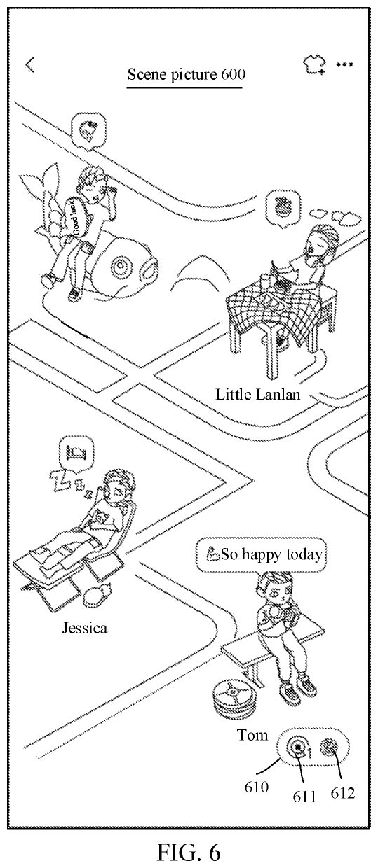

Exemplarily, FIG. 6 is a schematic diagram showing display content of a message navigator according to an embodiment of this disclosure. As shown in FIG. 6, a scene picture 600 corresponding to a virtual scene is currently displayed in a first observation range. When a social message (not shown in FIG. 6) transmitted from a second social account outside the first observation range is received, a message navigator 610 is displayed in the scene picture 600. The message navigator 610 includes an account identifier 611 and an account quantity 612 corresponding to the second social account. The account quantity 612 is displayed as “1”, indicating that only the social message transmitted from the second social account is currently received.

Operation 431: Determine a target position of a second social object in the virtual scene. For example, a location of the first virtual object is determined in the virtual scene.

Exemplarily, when a triggering operation performed on the message navigator is received, position information of the second social object is obtained from the virtual scene, including at least one of position coordinates, a position direction, a position distance, and the like.

The position coordinates refer to a coordinate point in which the virtual scene includes a world coordinate system and the second social object is located in the world coordinate system. The position direction refers to a relative position of the second social object in the scene picture corresponding to the current first observation range. The position distance refers to a distance between a position of the second social object and a central position of the scene picture corresponding to the current first observation range.

In some embodiments, a manner of determining the target position includes at least one of the following manners.

1. The virtual social object is located at a fixed position in the virtual scene. Therefore, a server (or a local terminal) has a file including position data corresponding to each virtual social object in the virtual scene stored therein. After the triggering operation performed on the message navigator is received, the position data corresponding to the second social object is obtained from the file, so as to obtain the target position of the second social object.

2. The social account may control the virtual social object to move in the virtual scene. During the movement of the virtual social object, the position data is generated in real time and transmitted to the server. After the triggering operation performed on the message navigator is received, most recently generated position data is obtained from the server, so as to obtain the target position of the second social object.

3. The social account may control the virtual social object to move in the virtual scene. After the triggering operation performed on the message navigator is received, the position data of the second social object in the virtual scene at a current moment is obtained, so as to obtain the target position of the second social object.

The foregoing manner of determining the target position is only a schematic example. This is not limited in the embodiments of this disclosure.

Operation 432: Display an animation in which an observation range of the virtual scene is switched from the first observation range to a second observation range in a direction corresponding to the target position, and use the animation as a scene movement animation. For example, a transition from the first view toward the location of the first virtual object is animated to arrive at the second view.

Alternatively, the scene movement animation in which the observation range of the virtual scene is switched from the first observation range to the second observation range in the direction corresponding to the target position may be displayed.

Exemplarily, the second observation range is determined based on the target position of the second social object in the virtual scene. To be specific, a central position of the second observation range is determined by using the target position corresponding to the second social object as a center. The second observation range is finally determined by using a focal length of a perspective of the first observation range as a focal length of a perspective of the second observation range.

In some embodiments, the scene movement animation refers to an animation in which the perspective is rotated to the second observation range in the direction of the target position of the second social object starting from the first observation range. An overlap exists between the first observation range and the second observation range.

In some embodiments, in the scene movement animation, the first observation range is switched to the second observation range at a preset constant speed. Alternatively, in the scene movement animation, the first observation range is switched to the second observation range with an initial speed of the preset speed and at a preset acceleration. This is not limited.

Operation 450: Cancel the display of the message navigator in the scene picture corresponding to the virtual scene displayed in the second observation range in response to a social message transmitted from a social account corresponding to a virtual social object outside the second observation range having not been received. For example, a first identifier of the first user account is removed from the message notification graphical element.

Exemplarily, when playback of the scene movement animation is completed and only the social message transmitted from the second social account is currently received, the second social object is displayed in the central position of the current scene picture during the display of the scene picture corresponding to the virtual scene in the second observation range, and prompt information corresponding to the social message is displayed at a designated position of the second social object.

In addition, since the social message transmitted from another social object is not received during the display of the scene picture corresponding to the virtual scene in the second observation range, display of the message navigator is canceled in the scene picture corresponding to the second observation range.

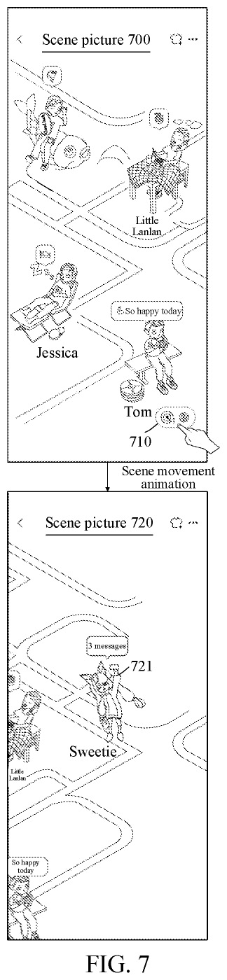

Exemplarily, FIG. 7 is a schematic diagram showing display of a second social object according to an embodiment of this disclosure. As shown in FIG. 7, a scene picture 700 corresponding to a virtual scene is first displayed in a first observation range. When a social message transmitted from a second social account is received (not shown in FIG. 7), a message navigator 710 is displayed in the scene picture 700. When a triggering operation performed on the message navigator 710 is received, a scene movement animation is displayed (not shown in FIG. 7). When playback of the scene movement animation is completed, a scene picture 720 corresponding to the virtual scene is currently displayed in a second observation range. The scene picture 720 is a picture in which a second social object 721 is located in the center of the picture after the first observation range is moved to the left. In addition, the message navigator 710 is not displayed in the scene picture 720.

Operation 460: Display message content corresponding to a social message and display a social animation of a second social object in response to a triggering operation performed on prompt information having been received. For example, in response to the second user input, content of the first message is displayed, and the first virtual object is animated in a manner corresponding to the content of the first message.

The social animation refers to an animation corresponding to the message content.

Exemplarily, the triggering operation performed on the prompt information is configured for viewing the message content corresponding to the social message transmitted from the second social account.

In some embodiments, the triggering operation performed on the prompt information is configured for representing simultaneous viewing of the message content of a plurality of social messages. Alternatively, the triggering operation performed on the prompt information only represents viewing of a single social message among the plurality of social messages. A number of triggering operations may correspond to a quantity of social messages. This is not limited.

In some embodiments, during the display of the message content corresponding to the social message is displayed, the second social object simultaneously displays the social animation. The social animation is an animation consistent with the message content of the social message.

In an example, if the social message transmitted from the second social account is “Invite you to dance”, the second social object plays an animation of “dance invitation” as the social animation during display of text content corresponding to the social message through the triggering operation performed on the prompt information.

In an example, if the social message transmitted from the second social account is implemented as sharing a selfie, the second social object performs an action of “taking a selfie” as the social animation during display of the selfie through the triggering operation performed on the prompt information.

Based on the above, according to the method for displaying a message provided in the embodiments of this disclosure, the scene picture corresponding to the virtual scene is currently displayed in the first observation range. When the social message transmitted from the second social account is received, the message navigator is displayed. When the triggering operation performed on the message navigator is received, the scene movement animation corresponding to switching from the first observation range to the second observation range is displayed, and the scene picture corresponding to the virtual scene is displayed in the second observation range. The current scene picture includes the second social object. In other words, when the second social account corresponding to the second social object outside the first observation range is controlled to transmit the social message, the observation range of the virtual scene can be automatically switched, by triggering the message navigator, to the observation range where the second social object is located, so as to achieve positioning of a position of the second social object in the virtual scene in one operation, thereby preventing a user from adjusting the observation range a plurality of times in the virtual scene to find the second social object, improving message display efficiency, and also reducing data overheads of a computer.

In this embodiment, the animation in which the first observation range is switched to the second observation range in the direction of the target position is displayed by determining the target position of the second social object, so that the scene movement animation is more directional and direction perception of a user for the second social object can be improved.

In this embodiment, after the playback of the scene movement animation is completed, the display of the message navigator is canceled when the second social object is displayed in the scene picture corresponding to the second observation range, so as to prompt the user that there is currently no social message from any other social account, thereby improving accuracy of message prompt.

In this embodiment, the account identifier and the account quantity corresponding to the social account that transmits the social message are displayed in the message navigator, so that a situation of the currently received social message can be learned more clearly, thereby improving accuracy and comprehensiveness of message display.

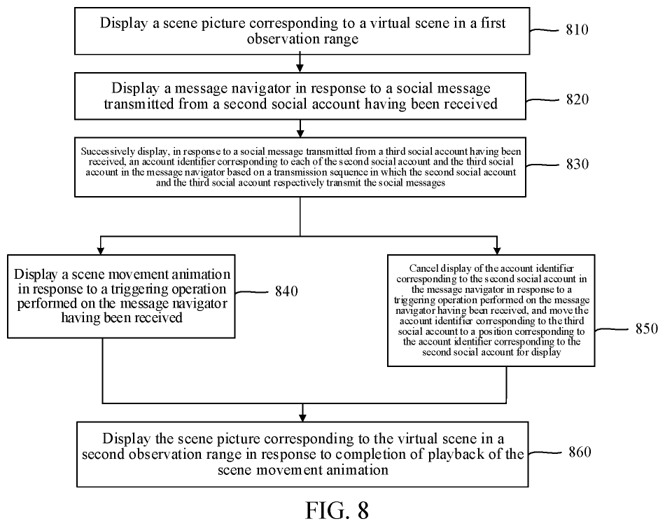

In an embodiment, an example in which only the social message transmitted from each of a plurality of social accounts is currently received is used for description. Exemplarily, FIG. 8 is a flowchart showing a method for displaying a message according to an embodiment of this disclosure. An example in which the method is performed by a terminal is used for description. As shown in FIG. 8, the method includes the following operations.

Operation 810: Display a scene picture corresponding to a virtual scene in a first observation range. For example, a first view of a virtual scene is displayed including virtual objects corresponding to user accounts.

The virtual scene includes a virtual social object corresponding to each of a plurality of social accounts, and includes a first social object corresponding to a first social account logged in with a terminal.

Exemplarily, the first observation range refers to a perspective range for observing the virtual scene from a third-person perspective corresponding to the first social object corresponding to the first social account logged in with the terminal.

In some embodiments, the first social object is located in the scene picture corresponding to the virtual scene currently displayed in the first observation range. Alternatively, the first social object is located outside the scene picture corresponding to the virtual scene currently displayed in the first observation range. This is not limited.

In some embodiments, in the virtual scene, each social account may control at least one virtual social object.

In some embodiments, each virtual social object in the virtual scene has a virtual social object with the same virtual image. Alternatively, each virtual social object in the virtual scene is a virtual social object with different virtual images. This is not limited.

Operation 820: Display a message navigator in response to a social message transmitted from a second social account having been received. For example, a message notification graphical element is displayed in response to the first message.

A second social object corresponding to the second social account is outside the first observation range. The message navigator is configured to indicate that a social message transmitted from a social account corresponding to a virtual social object outside the first observation range is received.

Exemplarily, the social account corresponding to the virtual social object in the virtual scene may transmit the social message. The social message includes at least one of types of messages such as a picture, a video, a text update, and voice for transmission.

In this embodiment, not only can the social message transmitted from the social account within the first observation range be received, but also a social message transmitted from a social account outside the first observation range can be received.

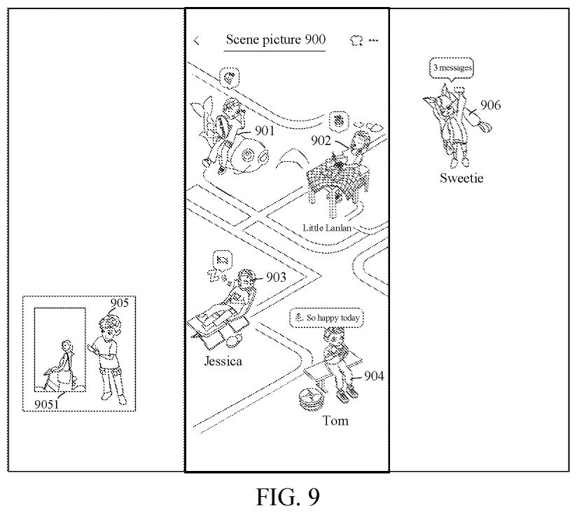

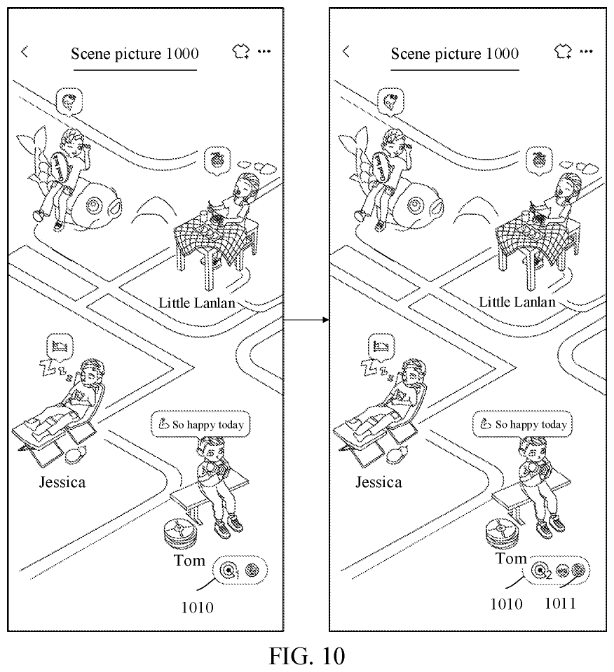

Exemplarily, FIG. 9 is a schematic diagram showing a position of a social account according to an embodiment of this disclosure. As shown in FIG. 9, a scene picture 900 corresponding to a virtual scene is currently displayed in a first observation range. The scene picture includes virtual social objects (an object 901, an object 902, an object 903, and an object 904) corresponding to four social accounts. In addition, social objects (an object 905 and an object 906) corresponding to two social accounts further exist in the virtual scene outside the first observation range. In this case, the object 905 transmits a social message 9051, and the social message 9051 is “having transmitted a picture”. The object 906 transmits a social message (only prompt information of the social message is displayed).

In this embodiment, when the social message transmitted from the second social account corresponding to the second social object outside the first observation range is received and a social message transmitted from another social account has not been received before, a message navigator is displayed in the scene picture corresponding to the first observation range, and an account identifier and an account quantity corresponding to the second social account are displayed in the message navigator (the quantity is 1, indicating that only a social message transmitted from one social account is currently received).

Operation 830: Successively display, in response to a social message transmitted from a third social account having been received, the account identifier corresponding to each of the second social account and the third social account in the message navigator based on a transmission sequence in which the second social account and the third social account respectively transmit the social messages. For example, a second message is received from a second user account corresponding to a second virtual object outside the first view. A receipt sequence of the first message and the second message is determined. The message notification graphical element to display identifiers is updated for the first user account and the second user account based on the determined receipt sequence.

A third social object corresponding to the third social account is outside the first observation range.

Exemplarily, during the display of the message navigator after the social message transmitted from the second social account is received, a social message transmitted from the third social account is further received. To be specific, a moment the third social account transmits the social message is later than a moment the second social account transmits the social message.

In some embodiments, the second social object and the third social object corresponding to the third social account are in the same observation range (i.e., a second observation range). Alternatively, the third social object and the second social object are in different observation ranges (the third social object is in the third observation range).

In this embodiment, when the social message transmitted from the third social account is received, the message navigator has been displayed in the scene picture corresponding to the first observation range in this case since the moment the third social account transmits the social message is later than the moment the second social account transmits the social message. Therefore, the social identifier corresponding to the third social account is added and displayed in the message navigator, and the account identifier corresponding to the third social account is located after the account identifier of the second social account. In addition, a numerical value of the account quantity in the message navigator is “increased by 1” to 2, and since the message navigator changes from displaying of one account identifier to displaying of two account identifiers, a control length of the message navigator increases accordingly.

Exemplarily, FIG. 10 is a schematic diagram showing display of a message navigator according to an embodiment of this disclosure. As shown in FIG. 10, a scene picture 1000 corresponding to a virtual scene is currently displayed in a first observation range. A social message transmitted from a second social account and a social message transmitted from a third social account have been successively received and have not been read currently, and a message navigator 1010 already exists currently in the scene picture 1000. Therefore, an account identifier 1011 of the third social account is added and displayed after an account identifier of the second social account in the message navigator 1010, and an account quantity in the message navigator 1010 changes to “2”. In addition, a control length of the message navigator 1010 also increases accordingly.

In an example, after the social message transmitted from the third social account has been received and have not been read, a social message transmitted from a fourth social account has been received. A fourth social object corresponding to the fourth social account is also a virtual social object outside the first observation range.

In some embodiments, an account identifier corresponding to the fourth social account is hidden in the message navigator in response to a social message transmitted from a fourth social account outside the first observation range having been received and a quantity of account identifiers currently displayed in the message navigator reaching a quantity threshold.

Exemplarily, the quantity threshold is configured for representing a maximum quantity of account identifiers that may be simultaneously displayed in a current message navigator.

Exemplarily, if a quantity of account identifiers displayed in the current message navigator has reached a saturation state, the account identifier corresponding to the fourth social account is no longer displayed in the message navigator and only a numerical value of the account quantity is increased in the message navigator when the social message transmitted from the fourth social account is received. For example, since the social message transmitted from each of the second social account and the third social account is currently received, the account quantity is 2. After the social message transmitted from the fourth social account is received, the account quantity is increased and displayed as “3”.

In some embodiments, in response to a social message transmitted from a fourth social account outside the first observation range having been received and a quantity of account identifiers currently displayed in the message navigator not reaching a quantity threshold, an account identifier corresponding to the fourth social account is displayed in the message navigator.

Exemplarily, if the social message transmitted from the fourth social account is received (in addition, a moment the fourth social account transmits the social message is later than a moment the third social account transmits the social message), and the quantity of the account identifiers displayed in the current message navigator does not reach the quantity threshold, the account identifier corresponding to the fourth social account is displayed after the account identifier corresponding to the third social account in the message navigator, and a numerical value of the account quantity in the message navigator is increased (increased to “3”) in the message navigator.

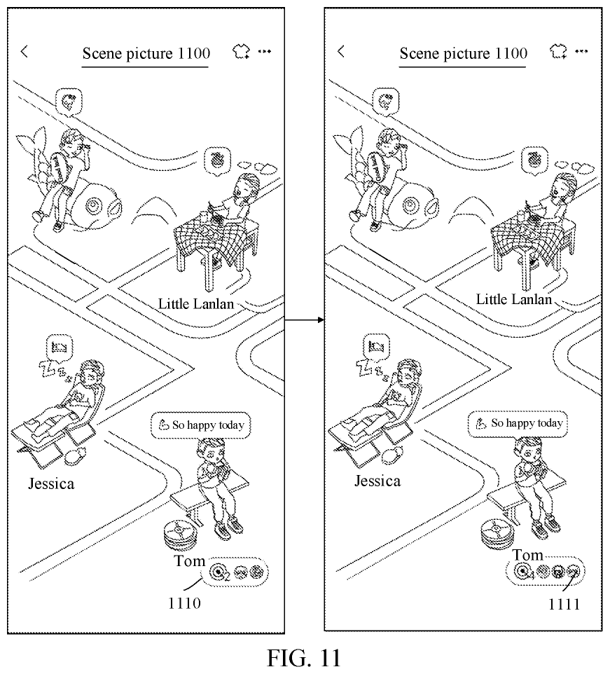

Exemplarily, FIG. 11 is a schematic diagram showing display of a message navigator according to an embodiment of this disclosure. As shown in FIG. 11, a scene picture 1100 corresponding to a virtual scene is currently displayed in a first observation range. A social message transmitted from each of a second social account and a third social account respectively has been received and has not been read currently. Therefore, an account identifier corresponding to each of the second social account and the third social account is currently displayed in a message navigator 1110, and an account quantity is “2”. After a social message transmitted from a fourth social account is received, a quantity of account identifiers currently displayed in the message navigator 1110 does not reach a quantity threshold. Therefore, in the message navigator 1110, an account identifier 1111 corresponding to the fourth social account is displayed after the account identifier corresponding to the third social account, and the account quantity increased to “3” is displayed. In addition, a control length of the message navigator 1110 is also correspondingly increased by a length of one account identifier.

In this embodiment, an arrangement sequence of the account identifiers displayed in the message navigator successively corresponds to the moment each social account transmits the social message.

Only a case where the social message transmitted from each social account outside the first observation range is received during current display of the scene picture corresponding to the virtual scene in the first observation range is described above. In this disclosure, when the social message transmitted from each social account outside the second observation range is received in a case that the scene picture corresponding to the virtual scene is subsequently displayed in the second observation range, display content of the message navigator is consistent with the foregoing display mode. The same is true for another observation range. Details are not described again later.

Operation 840: Display a scene movement animation in response to a triggering operation performed on the message navigator having been received. For example, an animation transitioning from the first view to the second view is displayed.

The scene movement animation is an animation in which an observation range of the virtual scene is switched from the first observation range to a second observation range. The second social object is within the second observation range.

In some embodiments, in response to a touch and hold operation performed on the message navigator having been received and an operation duration of the touch and hold operation reaches a preset time threshold, a message preview list is displayed in the scene picture corresponding to the virtual scene displayed in the first observation range. The message preview list includes a message preview identifier corresponding to the second social account. The scene movement animation is displayed in response to a triggering operation performed on the message preview identifier having been received.

In an implementable case, the message preview list is configured to represent social messages that are transmitted from all of the social accounts and have been received and have not been read currently. The message preview identifier includes an account identifier, an account name, and a social message quantity corresponding to each social account. After the triggering operation performed on the message preview identifier corresponding to the second social account is received, the scene movement animation is displayed.

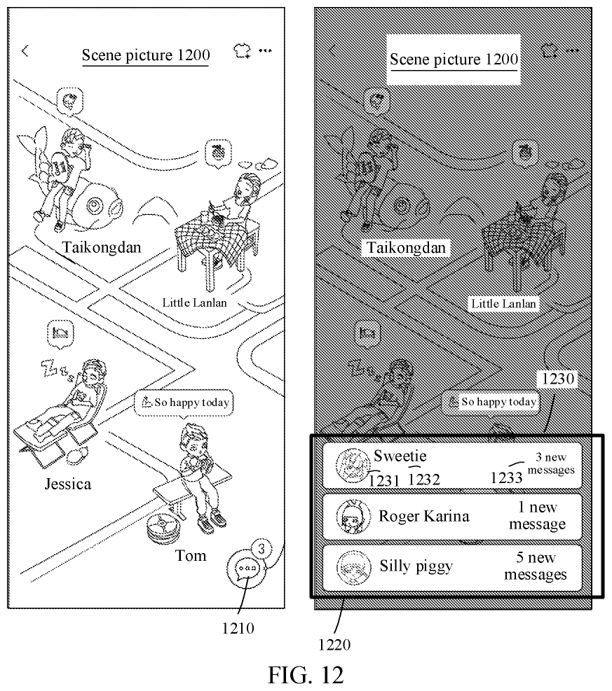

Exemplarily, FIG. 12 is a schematic diagram showing a message preview list according to an embodiment of this disclosure. As shown in FIG. 12, a scene picture 1200 corresponding to a virtual scene is currently displayed in a first observation range. When a social message transmitted from each of a second social account, a third social account, and a fourth social account is successively received (and has not been read), a message navigator 1210 is currently displayed. When a touch and hold operation performed on the message navigator 1210 is received, and an operation duration of the touch and hold operation reaches a preset time threshold, a message preview list 1220 is displayed in the current scene picture 1200. The message preview list 1220 includes a message preview identifier 1230 corresponding to the second social account, a message preview identifier corresponding to the third social account, and a message preview identifier corresponding to the fourth social account. The message preview identifier 1230 corresponding to the second social account includes an account identifier 1231 (an avatar), an account name 1232 (“sweetie”), and a social message quantity 1233 (“3 new messages”).

Operation 850: Cancel display of the account identifier corresponding to the second social account in the message navigator in response to a triggering operation performed on the message navigator having been received, and move the account identifier corresponding to the third social account to a position corresponding to the account identifier corresponding to the second social account for display. For example, a first identifier of the first user account is removed from the message notification graphical element. A second identifier of the second user account is shifted in the message notification graphical element.

A control length of the message navigator is related to an account identifier quantity.

Exemplarily, the social messages respectively transmitted from the second social account and the third social account are successively received during the display of the scene picture corresponding to the virtual scene in the first observation range. Therefore, after the triggering operation is performed on the message navigator, the display of the account identifier corresponding to the second social account is canceled, the account identifier corresponding to the third social account is moved to a position of the account identifier corresponding to the second social account, and finally the account identifier corresponding to the third social account is displayed at the position of the account identifier corresponding to the second social account. In addition, the control length of the message navigator is reduced by a length of one account identifier.

In some embodiments, the control length of the message navigator is positively correlated with the account identifier quantity.

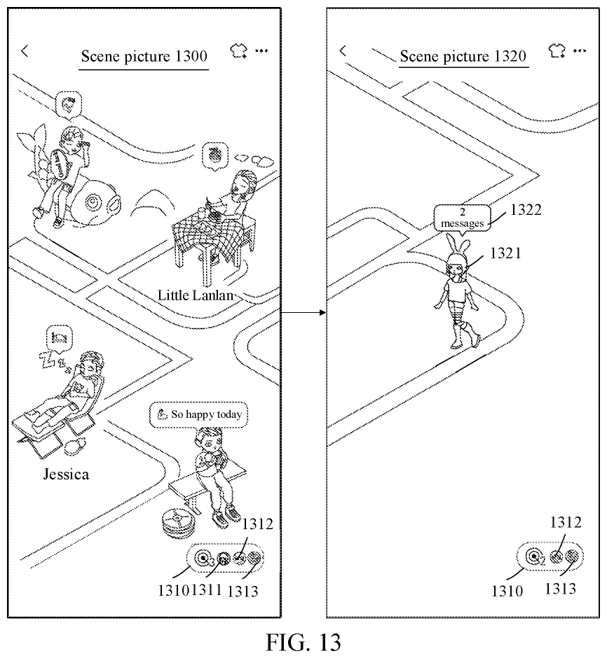

Exemplarily, FIG. 13 is a schematic diagram showing a display mode of an account identifier according to an embodiment of this disclosure. As shown in FIG. 13, a scene picture 1300 corresponding to a virtual scene is displayed in a first observation range. When a social message transmitted from each of a second social account, a third social account, and a fourth social account are successively received, a message navigator 1310 is displayed in the scene picture 1300. The message navigator 1310 includes an account identifier 1311 corresponding to the second social account, an account identifier 1312 corresponding to the third social account, an account identifier 1313 corresponding to the fourth social account, and an account quantity “3” (in this case, a quantity threshold is “3”. Therefore, all of the three account identifiers may be displayed).

When a triggering operation performed on the message navigator 1310 is received, a scene movement animation is displayed. After the display of the scene movement animation is completed, a scene picture 1320 corresponding to the virtual scene is displayed in a second observation range. The scene picture 1320 includes a second social object 1321 and prompt information 1322 corresponding to the social message. In addition, when the triggering operation performed on the message navigator 1310 is received, display of the account identifier 1311 corresponding to the second social account is canceled in the message navigator 1310, and the account identifier 1312 corresponding to the third social account is moved forward. Finally, the account identifier 1312 corresponding to the third social account, the account identifier 1313 corresponding to the fourth social account, and the account quantity of “2” are displayed in the message navigator 1310. In addition, a control length of the message navigator 1310 in the scene picture 1320 is shorter than a control length of the message navigator 1310 in the scene picture 1300 by a length of one account identifier.

In an implementable case, the social message transmitted from the fourth social account has been received, but a quantity of account identifiers displayed in the message navigator reaches a quantity threshold. Therefore, a situation of the account identifier corresponding to the fourth social account is not displayed. To be specific, in response to the social message transmitted from the fourth social account outside the first observation range having been received and the quantity of account identifiers currently displayed in the message navigator reaching the quantity threshold, the account quantity in the message navigator is updated, and an updated account quantity is displayed.

In some embodiments, in response to the triggering operation performed on the message navigator having been received, the display of the account identifier corresponding to the second social account is canceled in the message navigator, and the account identifier corresponding to the fourth social account is displayed in the message navigator.

In this embodiment, after the triggering operation performed on the message navigator is received, the display of the account identifier corresponding to the second social account is canceled in the message navigator, and the account identifier corresponding to the remaining social account in the message navigator is moved forward, so as to leave a slot for displaying the account identifier corresponding to the fourth social account.

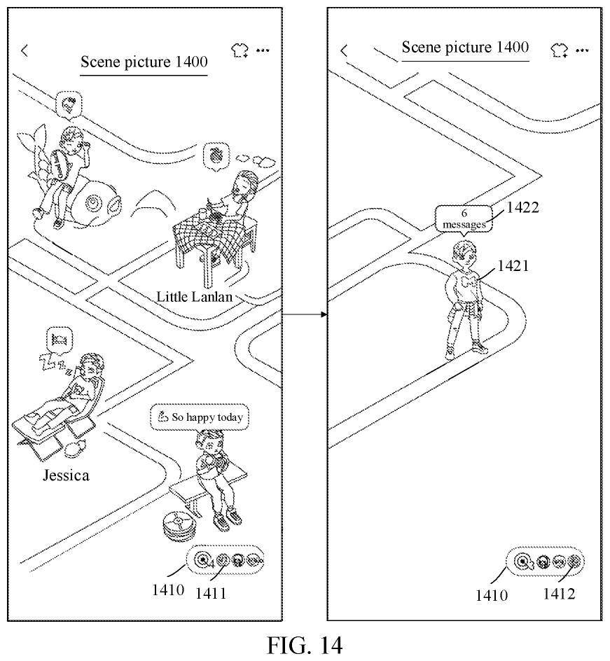

Exemplarily, FIG. 14 is a schematic diagram showing a display mode of an account identifier according to an embodiment of this disclosure. As shown in FIG. 14, a scene picture 1400 corresponding to a virtual scene is displayed in a first observation range. When social messages transmitted from a plurality of social accounts (including a second social account and a fourth social account) are successively received, a message navigator 1410 is displayed in the scene picture 1400. The message navigator 1410 includes an account identifier 1411 corresponding to the second social account and an account quantity of “4”. Since account identifiers corresponding to three social accounts have been currently displayed in the message navigator 1410, the account identifier corresponding to the fourth social account is not displayed in the message navigator 1410.

When a triggering operation performed on the message navigator 1410 is received, a scene movement animation is displayed. After the display of the scene movement animation is completed, a scene picture 1420 corresponding to the virtual scene is displayed in a second observation range. The scene picture 1420 includes a second social object 1421 and prompt information 1422 corresponding to the social message. In addition, the display of the account identifier 1411 corresponding to the second social account is canceled in the message navigator 1410, and the account identifier corresponding to another social account is moved forward. A slot is left at an end of the message navigator, and an account identifier 1412 corresponding to the fourth social account is displayed in the slot. Finally, the account identifier corresponding to the another social account, the account identifier 1412 corresponding to the fourth social account, and the account quantity of “3” are displayed in the message navigator 1410. In addition, a control length of the message navigator 1410 in the scene picture 1420 is equal to a control length of the message navigator 1410 in the scene picture 1400.

It may be learned from the foregoing content that when an observation range of the virtual scene is switched to the observation range of the virtual social object corresponding to the social account that transmits the social message, display of the account identifier corresponding to the social account is canceled in the message navigator, and successive ordering is performed based on a moment sequence in which the remaining social accounts in the message navigator transmit the social messages.

Operation 860: Display the scene picture corresponding to the virtual scene in the second observation range in response to completion of playback of the scene movement animation. For example, the second view is displayed when the animation is completed.

Prompt information corresponding to the social message is displayed in a designated area corresponding to the second social object.

The content regarding the social message and the prompt information in operation 860 have been described in detail in the foregoing embodiments. Details are not described herein again.

In an example, in a case that the account identifier corresponding to each of the plurality of social accounts that transmits the social message is displayed in the message navigator, the triggering operation may be performed for different account identifiers.

In an example, in response to the corresponding triggering operation performed on each of the plurality of account identifiers having been received, a triggering sequence corresponding to each of the plurality of account identifiers is determined. Based on the triggering sequence, a multi-dimensional scene movement animation is displayed. The multi-dimensional scene movement animation refers to, based on the triggering sequence, successive and continuous switching of the observation range of the virtual scene from the first observation range to an observation range where the virtual social object corresponding to each of the plurality of social accounts is located.

In this example, a sequence of the triggering moments respectively corresponding to the plurality of account identifiers is determined by successively performing a triggering operation on the plurality of account identifiers in the message navigator. Based on the sequence of the triggering moments, it is displayed that the observation range starts from the first observation range and is successively switched to the observation range where the virtual social object corresponding to the social account corresponding to the foregoing account identifier is located, which is used as the multi-dimensional scene movement animation.

In an example, the message navigator includes an account identifier 1 corresponding to an account A (the account A corresponds to an object a, and the object a is within the second observation range), an account identifier 2 corresponding to an account B (the account B corresponds to an object b, and the object b is within a third observation range), and an account identifier 3 corresponding to an account C (the account C corresponds to an object c, and the object c is within a fourth observation range).

When the triggering operations successively performed on the account identifier 2, the account identifier 3, and the account identifier 1 are received, the corresponding multi-dimensional scene movement animation in which the observation range of the virtual scene is first switched from the first observation range to the third observation range, then switched from the third observation range to the fourth observation range, and finally switched to the second observation range is displayed based on the sequence of the triggering operations. During playback of the multi-dimensional scene movement animation, a user may pause animation playback based on an actual need, and display the scene picture corresponding to the observation range switched to at the time of the pause.

Based on the above, according to the method for displaying a message provided in the embodiments of this disclosure, the scene picture corresponding to the virtual scene is currently displayed in the first observation range. When the social message transmitted from the second social account is received, the message navigator is displayed. When the triggering operation performed on the message navigator is received, the scene movement animation corresponding to switching from the first observation range to the second observation range is displayed, and the scene picture corresponding to the virtual scene is displayed in the second observation range. The current scene picture includes the second social object. In other words, when the second social account corresponding to the second social object outside the first observation range is controlled to transmit the social message, the observation range of the virtual scene can be automatically switched, by triggering the message navigator, to the observation range where the second social object is located, so as to achieve positioning of a position of the second social object in the virtual scene in one operation, thereby preventing a user from adjusting the observation range a plurality of times in the virtual scene to find the second social object, improving message display efficiency, and also reducing data overheads of a computer.

In this embodiment, the account identifier corresponding to each social account is successively displayed in the message navigator based on a transmission sequence of the social message transmitted from the received social account, so that a transmission time of the social message can be displayed more specifically, thereby improving accuracy of message display.

In this embodiment, a quantity threshold corresponding to the account identifier is preset, so that the control length of the message navigator can be stabilized within a fixed range, thereby improving aesthetics of the message navigator.

In this embodiment, after the scene picture corresponding to the virtual scene is displayed in the second observation range, the display of the account identifier corresponding to the second social account is canceled, and the account identifiers corresponding to the remaining social accounts are moved, so that efficiency and accuracy of message prompt can be improved.

In this embodiment, a triggering operation is performed on a message preview identifier of the second social object by displaying a message preview list, so that the user can preview the social message transmitted from the currently received social account and then determine whether to obtain the social message transmitted from the second social account, thereby improving content richness of message display.

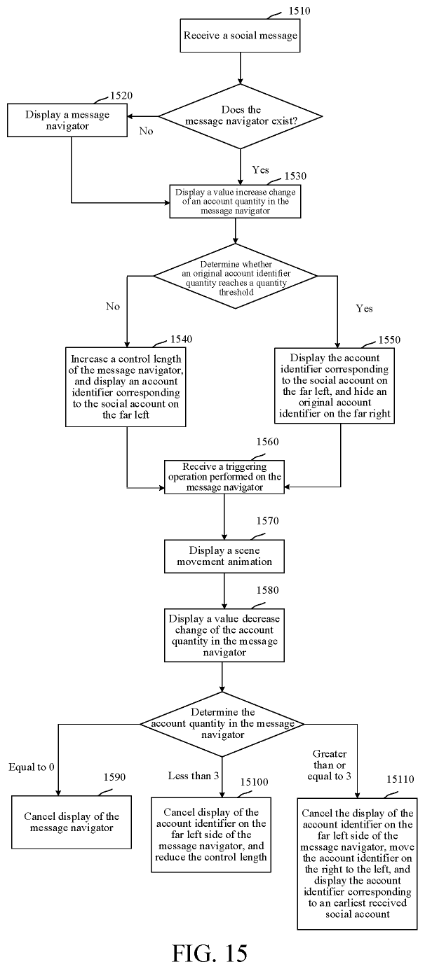

In an embodiment, an example in which the method for displaying a message is applied to a social game is used for description. Exemplarily, FIG. 15 is a flowchart showing a method for displaying a message according to an embodiment of this disclosure. As shown in FIG. 15, the method includes the following operations.

Operation 1510: Receive a social message.

Exemplarily, a scene picture corresponding to a virtual social scene is displayed in a first observation range. A virtual social scene includes a virtual social object corresponding to each of a plurality of social accounts.

When a terminal receives a social message transmitted from a second social account outside a first observation range (or a new message is generated from outside the first observation range), a navigator mechanism is triggered. It is determined whether a message navigator exists in a current scene picture. If no message navigator exists, operation 1520 is performed, and if the message navigator exists, operation 1530 is performed.

Operation 1520: Display a message navigator.

Since a social message transmitted from another social account outside the first observation range is not currently received (or no new message is generated outside the first observation range), the message navigator is displayed in the scene picture. The message navigator includes an account identifier corresponding to the second social account and an account quantity of “1”.

Operation 1530: Display a value increase change of the account quantity in the message navigator.

If the message navigator has been displayed in a current scene picture, the value increase change of the account quantity is displayed in the message navigator, and a specific implementation is an increase of “1” (for example, if an original account quantity is “3”, the account quantity changes to “4” after the value increase).

Based on the currently displayed account identifier in a current message navigator, an operation is performed on an account identification area.

Since an upper limit of the quantity of the account identifiers displayed in the message navigator exists, a quantity threshold is set to 3 in this embodiment. If an original account identifier quantity does not reach the quantity threshold, operation 1540 is performed. If the original account identifier quantity has reached the quantity threshold, operation 1550 is performed.

Operation 1540: Increase a control length of the message navigator, and display an account identifier corresponding to the social account on the far left.

If the account identifier quantity displayed in the original message navigator does not reach 3, the account identifier corresponding to the second social account is displayed on a far left side of the message navigator, indicating that the social message currently transmitted from the second social account is a latest message that is transmitted. In addition, the control length of the current message navigator is increased by a length of one account identifier.

Operation 1550: Display the account identifier corresponding to the social account on the far left, and hide an original account identifier on the far right.

If the account identifier quantity displayed in the original message navigator has reached 3, the account identifier corresponding to the second social account is displayed on the far left side of the message navigator. The account identifier originally displayed in the message navigator is successively moved to the right by a position of one account identifier, and the account identifier originally located on the far right side in the message navigator is hidden.

To be specific, a sequence in which the account identifiers are arranged from left to right in the current message navigator corresponds to an order of transmission when the social account transmits the social message.

Operation 1560: Receive a triggering operation performed on the message navigator.

A user may trigger a positioning display function by clicking/tapping the message navigator.

Operation 1570: Display a scene movement animation.

Based on a clicking/tapping operation performed on the message navigator by the user, switching from the first observation range to a second observation range where a second social object corresponding to the second social account that transmits the social message most recently is located is displayed.

Operation 1580: Display a value decrease change of the account quantity in the message navigator.

During playback of the scene movement animation, content displayed in the message navigator also changes accordingly.

First, the account quantity displayed in the message navigator is to be reduced after the playback of the scene movement animation is completed. For example, the original account quantity is “3”. After the playback of the scene movement animation is completed, the account quantity is “2”. A display change corresponding to the account identifier in the message navigator is determined based on a current reduced number.

Operation 1590: Cancel display of the message navigator.

If the reduced account quantity is “0”, the display of the message navigator is canceled in the scene picture corresponding to the second observation range.

Operation 15100: Cancel display of the account identifier on the far left side of the message navigator, and reduce the control length.

If the reduced account quantity is less than 3, i.e., 1 or 2, the account identifier corresponding to the second social account located on the far left side of the message navigator is first hidden, and then the control length of the message navigator is reduced by the length of the account identifier.

Operation 15110: Cancel the display of the account identifier on the far left side of the message navigator, move the account identifier on the right to the left, and display the account identifier corresponding to an earliest received social account.

If the reduced account quantity is greater than or equal to 3, the account identifier corresponding to the second social account located on the far left side of the message navigator is first hidden, and then another account identifier displayed in the current message navigator is moved to the left by a distance of one account identifier. Finally, the account identifier corresponding to the social account that transmits the social message earliest is redisplayed on the far right side of the message navigator.

Based on the above, according to the method for displaying a message provided in the embodiments of this disclosure, the scene picture corresponding to the virtual scene is currently displayed in the first observation range. When the social message transmitted from the second social account is received, the message navigator is displayed. When the triggering operation performed on the message navigator is received, the scene movement animation corresponding to switching from the first observation range to the second observation range is displayed, and the scene picture corresponding to the virtual scene is displayed in the second observation range. The current scene picture includes the second social object. In other words, when the second social account corresponding to the second social object outside the first observation range is controlled to transmit the social message, the observation range of the virtual scene can be automatically switched, by triggering the message navigator, to the observation range where the second social object is located, so as to achieve positioning of a position of the second social object in the virtual scene in one operation, thereby preventing a user from adjusting the observation range a plurality of times in the virtual scene to find the second social object, improving message display efficiency, and also reducing data overheads of a computer.

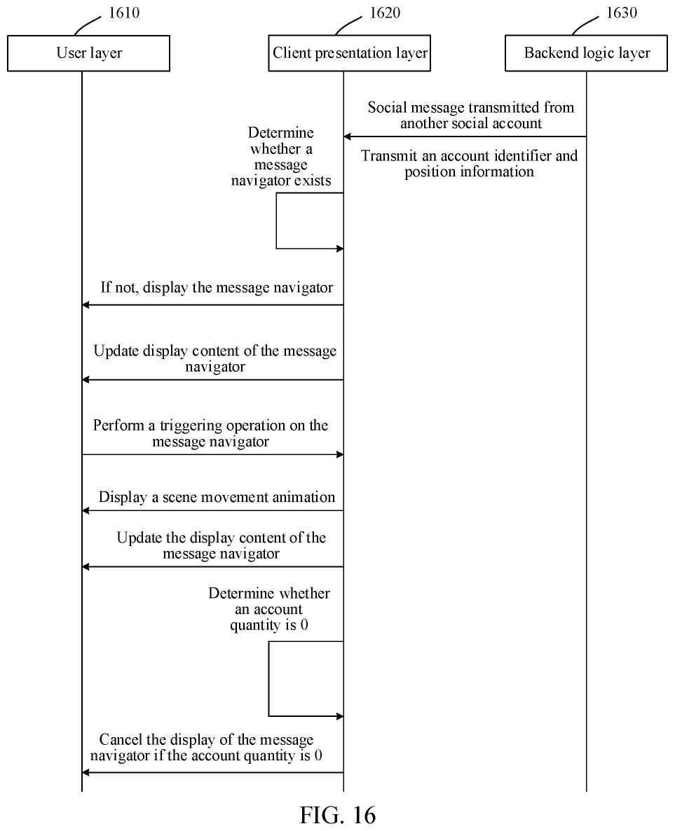

Exemplarily, FIG. 16 is a timing diagram showing a method for displaying a message according to an embodiment of this disclosure. As shown in FIG. 16, the method includes the following content.

First, a current timing diagram includes a user layer 1610, a client presentation layer 1620, and a backend logic layer 1630. The user layer 1610 is implemented as picture content displayed to a user by a terminal. The client presentation layer 1620 is configured to render a numerical value generated by a server on a terminal interface. The backend logic layer 1630 is implemented for code setting and processing.

First, after the backend logic layer 1630 receives a social message transmitted from another social account outside a first observation range, an account identifier corresponding to the social account and position information of a virtual social object corresponding to the social account in a virtual scene are generated and transmitted to the client presentation layer 1620.

The client presentation layer 1620 determines, based on the account identifier and the position information that are received, whether a message navigator exists in the current scene picture. If no message navigator exists, the message navigator is displayed to the user layer 1610 in the scene picture. If the message navigator already exists, display content of the message navigator is updated to the user layer 1610 in the scene picture (for example, the account identifier and an account quantity are updated, and an updated account identifier and an updated account quantity are displayed).

A player may perform a triggering operation on the message navigator through the user layer 1610, and transmits the triggering operation to the client presentation layer 1620. The client presentation layer 1620 displays a scene movement animation to the user layer 1610 based on the triggering operation, and updates the display content corresponding to the current message navigator. It is determined based on the updated display content whether the account quantity is 0. If the account quantity is 0, the display of the message navigator being canceled in the scene picture after switching is displayed to the user layer 1610.

Based on the above, according to the method for displaying a message provided in the embodiments of this disclosure, the scene picture corresponding to the virtual scene is currently displayed in the first observation range. When the social message transmitted from the second social account is received, the message navigator is displayed. When the triggering operation performed on the message navigator is received, the scene movement animation corresponding to switching from the first observation range to the second observation range is displayed, and the scene picture corresponding to the virtual scene is displayed in the second observation range. The current scene picture includes the second social object. In other words, when the second social account corresponding to the second social object outside the first observation range is controlled to transmit the social message, the observation range of the virtual scene can be automatically switched, by triggering the message navigator, to the observation range where the second social object is located, so as to achieve positioning of a position of the second social object in the virtual scene in one operation, thereby preventing a user from adjusting the observation range a plurality of times in the virtual scene to find the second social object, improving message display efficiency, and also reducing data overheads of a computer.

The method for displaying a message provided in this disclosure can resolve a pain point of searching the virtual scene for a specific virtual object. By providing a clear and easy-to-use positioning display function, an operation experience of a user is simplified, and use efficiency of message display is improved. In addition, the solution provided in this disclosure has low development costs and performance requirements and is highly cost-effective.

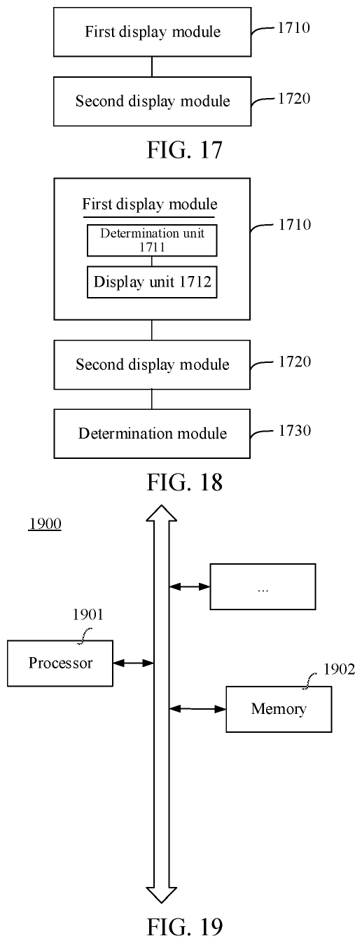

FIG. 17 is a structural block diagram of an apparatus for displaying a message according to an embodiment of this disclosure. As shown in FIG. 17, the apparatus includes the following parts:
a first display module 1710, configured to display a scene picture corresponding to a virtual scene in a first observation range, the virtual scene including a virtual social object corresponding to each of a plurality of social accounts, and including a first social object corresponding to a first social account logged in with a terminal;
the first display module 1710 being further configured to display a message navigator in response to a social message transmitted from a second social account having been received, a second social object corresponding to the second social account being outside the first observation range, and the message navigator being configured to indicate that a social message transmitted from a social account corresponding to a virtual social object outside the first observation range is received; and
a second display module 1720, configured to display the scene picture corresponding to the virtual scene in a second observation range in response to a triggering operation performed on the message navigator having been received, the second social object being within the second observation range, and prompt information corresponding to the social message being displayed in a designated area corresponding to the second social object.

In some embodiments, the first display module is further configured to display a scene movement animation in response to the triggering operation performed on the message navigator having been received, the scene movement animation being an animation in which an observation range of the virtual scene is switched from the first observation range to the second observation range; and the second display module is configured to display the scene picture corresponding to the virtual scene in the second observation range in response to completion of playback of the scene movement animation.

In some embodiments, as shown in FIG. 18, the first display module 1710 includes:
a determination unit 1711, configured to determine a target position of the second social object in the virtual scene; and
a display unit 1712, configured to display the scene movement animation in which the observation range of the virtual scene is switched from the first observation range to the second observation range in a direction corresponding to the target position.

In some embodiments, the second display module 1720 is further configured to cancel the display of the message navigator in the scene picture corresponding to the virtual scene displayed in the second observation range in response to a social message transmitted from a social account corresponding to a virtual social object outside the second observation range having not been received.

In some embodiments, the message navigator includes an account identifier and an account quantity corresponding to the social account that transmits the social message, the account quantity corresponding to a quantity of social accounts from which the social messages have been received and have not been read currently.

In some embodiments, the first display module 1710 is further configured to successively display, in response to a social message transmitted from a third social account having been received, the account identifier corresponding to each of the second social account and the third social account in the message navigator based on a transmission sequence in which the second social account and the third social account respectively transmit the social messages, a third social object corresponding to the third social account being outside the first observation range.

In some embodiments, a moment the third social account transmits the social message is later than a moment the second social account transmits the social message.

The second display module 1720 is further configured to cancel display of the account identifier corresponding to the second social account in the message navigator in response to the triggering operation performed on the message navigator having been received, and move the account identifier corresponding to the third social account to a position corresponding to the account identifier corresponding to the second social account for display, a control length of the message navigator being related to the account quantity.

In some embodiments, the first display module 1710 is further configured to hide, in response to a social message transmitted from a fourth social account outside the first observation range having been received and a quantity of account identifiers currently displayed in the message navigator reaching a quantity threshold, an account identifier corresponding to the fourth social account in the message navigator.

In some embodiments, the second display module 1720 is further configured to cancel the display of the account identifier corresponding to the second social account in the message navigator in response to the triggering operation performed on the message navigator having been received, and display the account identifier corresponding to the fourth social account in the message navigator.

In some embodiments, the first display module 1710 is further configured to: display, in response to the social message transmitted from the fourth social account outside the first observation range having been received and the quantity of account identifiers currently displayed in the message navigator not reaching the quantity threshold, the account identifier corresponding to the fourth social account in the message navigator; and update the account quantity in the message navigator and display an updated account quantity in response to the social message transmitted from the fourth social account outside the first observation range having been received and the quantity of account identifiers currently displayed in the message navigator reaching the quantity threshold.

In some embodiments, the second display module 1720 is further configured to, in response to the triggering operation performed on the prompt information having been received, display message content corresponding to the social message and display a social animation of the second social object, the social animation being an animation corresponding to the message content.

In some embodiments, the first display module 1710 is further configured to: display a message preview list in the scene picture corresponding to the virtual scene displayed in the first observation range in response to a touch and hold operation performed on the message navigator having been received, the message preview list including a message preview identifier corresponding to the second social account; and display the scene movement animation in response to a triggering operation performed on the message preview identifier having been received.

For example, the first display module 1710 is further configured to: display, in response to a touch and hold operation performed on the message navigator having been received and an operation duration of the touch and hold operation reaches a preset time threshold, a message preview list in the scene picture corresponding to the virtual scene displayed in the first observation range, the message preview list including a message preview identifier corresponding to the second social account; and display the scene movement animation in response to a triggering operation performed on the message preview identifier having been received.

In some embodiments, the account identifier corresponding to each of a plurality of social accounts that transmits the social message is displayed in the message navigator.

The apparatus further includes:

a determination module 1730, configured to determine, in response to a corresponding triggering operation performed on each of the plurality of account identifiers having been received, a triggering sequence corresponding to each of the plurality of account identifiers.

The second display module 1720 is further configured to display a multi-dimensional scene movement animation based on the triggering sequence. The multi-dimensional scene movement animation refers to, based on the triggering sequence, successive and continuous switching of the observation range of the virtual scene from the first observation range to an observation range where the virtual social object corresponding to each of the plurality of social accounts is located.

In other words, the second display module 1720 is further configured to successively switch, based on the triggering sequence, the observation range of the virtual scene from the first observation range to an observation range where the virtual social object corresponding to each of the plurality of social accounts is located.

Based on the above, according to the apparatus for displaying a message provided in the embodiments of this disclosure, the scene picture corresponding to the virtual scene is currently displayed in the first observation range. When the social message transmitted from the second social account is received, the message navigator is displayed. When the triggering operation performed on the message navigator is received, the scene movement animation corresponding to switching from the first observation range to the second observation range is displayed, and the scene picture corresponding to the virtual scene is displayed in the second observation range. The current scene picture includes the second social object. In other words, when the second social account corresponding to the second social object outside the first observation range is controlled to transmit the social message, the observation range of the virtual scene can be automatically switched, by triggering the message navigator, to the observation range where the second social object is located, so as to achieve positioning of a position of the second social object in the virtual scene in one operation, thereby preventing a user from adjusting the observation range a plurality of times in the virtual scene to find the second social object, improving message display efficiency, and also reducing data overheads of a computer.

For the apparatus for displaying a message provided in the foregoing embodiments, only division of the functional modules is described by using examples. In practical application, the functions may be completed by different functional modules as required. To be specific, an internal structure of the device is divided into different functional modules to complete all or part of the functions described above. In addition, the apparatus for displaying a message provided in the foregoing embodiment belongs to the same idea as the embodiment of the method for displaying a message. For a specific implementation process thereof, reference is made to the method embodiment. Details are not described herein again.

FIG. 19 is a structural block diagram showing a terminal 1900 according to an embodiment of this disclosure. The terminal 1900 may be a smartphone, a tablet computer, an MP3 player, an MP4 player, a notebook computer, or a desktop computer. The terminal 1900 may also be referred to as another name such as user equipment, a portable terminal, a laptop terminal, or a desktop terminal.

The terminal 1900 usually includes a processor 1901 (e.g., processing circuitry) and a memory 1902 (e.g., a non-transitory computer-readable storage medium).

The processor 1901 may include one or more processing cores, such as a 4-core processor and an 8-core processor. The processor 1901 may be implemented in at least one hardware form of a digital signal processor (DSP), a field-programmable gate array (FPGA), and a programmable logic array (PLA). The processor 1901 may also include a main processor and a coprocessor. The main processor is a processor configured to process data in an awake state, and is also referred to as a central processing unit (CPU). The coprocessor is a low-power processor configured to process data in a standby state. In some embodiments, the processor 1901 may be integrated with a graphics processing unit (GPU). The GPU is configured to render and draw content that needs to be displayed on a display screen. In some embodiments, the processor 1901 may further include an artificial intelligence (AI) processor. The AI processor is configured to process computing operations related to machine learning.

The memory 1902 may include one or more computer-readable storage media. The computer-readable storage medium may be non-transient. The memory 1902 may further include a high-speed random access memory (RAM) and a nonvolatile memory, such as one or more disk storage devices or flash storage devices. In some embodiments, the non-transitory computer-readable storage medium in the memory 1902 is configured to store at least one instruction. The at least one instruction is configured for being executed by the processor 1901 to implement the method for displaying a message provided in the method embodiment of this disclosure.

In some embodiments, the terminal 1900 further includes another component. A person skilled in the art may understand that the structure shown in FIG. 19 does not constitute a limitation on the terminal 1900. The terminal may include more or fewer components than those shown in the figure, or some merged components, or different component arrangements.

A person of ordinary skill in the art may understand that all or some of the operations of the methods in the embodiments may be implemented by a program instructing relevant hardware. The program may be stored in a computer-readable storage medium, such as a non-transitory computer-readable storage medium. The computer-readable storage medium may be the computer-readable storage medium included in the memory in the foregoing embodiment, or may be a computer-readable storage medium that exists alone and is not assembled into a terminal. The computer-readable storage medium has at least one instruction, at least one program, a code set, or an instruction set stored therein, the at least one instruction, the at least one program, the code set, or the instruction set being loaded and executed by a processor to implement the method for displaying a message according to any one of the foregoing embodiments.

In some embodiments, the computer-readable storage medium may include a read-only memory (ROM), a random access memory (RAM), a solid state drive (SSD), an optical disc, or the like. The RAM may include a resistance RAM (ReRAM) and a dynamic RAM (DRAM). The serial numbers of the foregoing embodiments of this disclosure are merely used as examples for description, and do not represent the preference of the embodiments.

A person of ordinary skill in the art may understand that all or part of the operations of implementing the foregoing embodiments may be implemented by hardware, or may be implemented by a program instructing related hardware. The program may be stored in a computer-readable storage medium. The storage medium mentioned above may be a ROM, a magnetic disk, an optical disc, or the like.

What is claimed is:

1. A method for displaying messages in a virtual environment, the method comprising:
displaying a first view of a virtual scene including virtual objects corresponding to user accounts;
receiving a first message from a first user account corresponding to a first virtual object located outside the first view;
displaying a message notification graphical element in response to the first message;
receiving a first user input selecting the message notification graphical element; and
displaying a second view of the virtual scene in response to the first user input, wherein the second view includes the first virtual object and displays a message prompt corresponding to the first virtual object, and
the second view is different from the first view.

2. The method according to claim 1, wherein the displaying the second view comprises:
displaying an animation transitioning from the first view to the second view; and
displaying the second view when the animation is completed.

3. The method according to claim 2, wherein the displaying the animation comprises:
determining a location of the first virtual object in the virtual scene; and
animating a transition from the first view toward the location of the first virtual object to arrive at the second view.

4. The method according to claim 1, further comprising:
determining an absence of messages from the virtual objects outside the second view; and
removing the message notification graphical element from display when the second view is displayed and the absence of messages from the virtual objects outside the second view is determined.

5. The method according to claim 1, wherein the message notification graphical element displays an identifier and a count of the user accounts corresponding to received unread messages.

6. The method according to claim 1, further comprising:
receiving a second message from a second user account corresponding to a second virtual object outside the first view;
determining a receipt sequence of the first message and the second message; and
updating the message notification graphical element to display identifiers for the first user account and the second user account based on the determined receipt sequence.

7. The method according to claim 6, further comprising:
removing a first identifier of the first user account from the message notification graphical element;
shifting a second identifier of the second user account in the message notification graphical element; and
adjusting a size of the message notification graphical element based on a number of displayed identifiers in the message notification graphical element.

8. The method according to claim 6, further comprising:
receiving a third message from a third user account;
determining a maximum number of identifiers are displayed in the message notification graphical element; and
in response to the first user input, removing a first identifier of the first user account and adding a third identifier of the third user account to the message notification graphical element.

9. The method according to claim 8, further comprising:
when the maximum number of identifiers are not displayed, adding the third identifier of the third user account to the message notification graphical element; and
when the maximum number of identifiers are displayed, updating a count of the user accounts with unread messages in the message notification graphical element.

10. The method according claim 1, further comprising:
receiving a second user input selecting the displayed message prompt; and
in response to the second user input, displaying content of the first message and animating the first virtual object in a manner corresponding to the content of the first message.

11. The method according to claim 2, wherein the displaying the animation comprises:
receiving a user input on the message notification graphical element of at least a predefined duration;
displaying a message preview list including a preview for the first message from the first user account; and
initiating the animation in response to selection of the preview.

12. The method according to claim 1, wherein the message notification graphical element includes identifiers for a plurality of user accounts with unread messages; and
the method further comprises:
receiving a plurality of user inputs selecting a plurality of identifiers in the message notification graphical element;
determining an order of selection of the plurality of identifiers; and
sequentially displaying views of the virtual scene showing virtual objects corresponding to the selected identifiers from the plurality of identifiers in the determined order of selection.

13. An apparatus, comprising:
processing circuitry configured to:
display a first view of a virtual scene including virtual objects corresponding to user accounts;
receive a first message from a first user account corresponding to a first virtual object located outside the first view;
display a message notification graphical element in response to the first message;
receive a first user input to select the message notification graphical element; and
display a second view of the virtual scene in response to the first user input, wherein
the second view includes the first virtual object and displays a message prompt corresponding to the first virtual object, and
the second view is different from the first view.

14. The apparatus according to claim 13, wherein the processing circuitry is configured to:
display an animation transitioning from the first view to the second view; and
display the second view when the animation is completed.

15. The apparatus according to claim 14, wherein the processing circuitry is configured to:
determine a location of the first virtual object in the virtual scene; and
animate a transition from the first view toward the location of the first virtual object to arrive at the second view.

16. The apparatus according to claim 13, wherein the processing circuitry is configured to:
determine an absence of messages from the virtual objects outside the second view; and
remove the message notification graphical element from display when the second view is displayed and the absence of messages from the virtual objects outside the second view is determined.

17. The apparatus according to claim 13, wherein the message notification graphical element displays an identifier and a count of the user accounts corresponding to received unread messages.

18. The apparatus according to claim 13, wherein the processing circuitry is configured to:
receive a second message from a second user account corresponding to a second virtual object outside the first view;
determine a receipt sequence of the first message and the second message; and
update the message notification graphical element to display identifiers for the first user account and the second user account based on the determined receipt sequence.

19. The apparatus according to claim 18, wherein the processing circuitry is configured to:
remove a first identifier of the first user account from the message notification graphical element;
shift a second identifier of the second user account in the message notification graphical element; and
adjust a size of the message notification graphical element based on a number of displayed identifiers in the message notification graphical element.

20. A non-transitory computer-readable storage medium, storing instructions which when executed by a processor cause the processor to perform:
displaying a first view of a virtual scene including virtual objects corresponding to user accounts;
receiving a first message from a first user account corresponding to a first virtual object located outside the first view;
displaying a message notification graphical element in response to the first message;
receiving a first user input selecting the message notification graphical element; and
displaying a second view of the virtual scene in response to the first user input, wherein
the second view includes the first virtual object and displays a message prompt corresponding to the first virtual object, and
the second view is different from the first view.
